(19) United States
(12) Patent Application Publication
(10) Pub. No.: US 2020/0017268 A1
(43) Pub. Date: Jan. 16, 2020

(54) SOFT PACKAGE WITH STRENGTHENED HOT PRESSING TRACES AND MANUFACTURING METHOD THEREOF

(71) Applicant: Lu-Wen CHANG, Taichung City (TW)

(72) Inventor: Lu-Wen CHANG, Taichung City (TW)

(21) Appl. No.: 16/033,975

(22) Filed: Jul. 12, 2018

(51) Int. Cl. B65D 75/00; B65D 75/58; B29C 65/78; B29C 65/02; B29C 65/00

(52) U.S. Cl. CPC B65D 75/008; B65D 75/5877; B29C 65/7832; B29L 2031/712; B29C 66/43; B29C 66/47421; B65D 2575/586; B29C 65/02

(57) ABSTRACT

A soft package with strengthened hot pressing traces includes a first side wall and a second side wall formed with a folded portion along a folding line and the distal edge of the second side wall is securely adhered to that of the first side wall except of the folding line and the distal edge of the folded portion. A top wall is divided into a first portion and a second portion, wherein a distal edge of the first portion of the top wall is securely adhered to that of the folded portion and a distal edge of the second portion is securely adhered to that of a top portion of the first side wall to form a bag structure. Two strengthened pressing traces are formed on two opposite sides of the top wall. A nozzle is mounted onto the top wall and outwardly extending through the top wall.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a soft package, and more particularly to a soft package with strengthened hot pressing traces and a manufacturing method thereof.

### 2. Description of Related Art Including Information Disclosed Under 37 CFR 1.97 And 37 CFR 1.98

A conventional soft package in accordance with the prior art is depicted in FIG. 9, wherein the bottom 03 of the soft package 02 can be expanded physically into a bigger area, and the top 04 can be compressed in a flat pattern. However, the following shortcomings are observed during actual applications:

First, regarding the stability of arrangement: the side wall 05 is tilted when the conventional soft package 02 is expanded by some objects, so the bottom wall of the conventional soft package 02 will be stretched into an arced shape. In such case, only two opposite corners of the bottom 03 of the conventional soft package 02 are stably supported, leading to instability of the conventional soft package 02. Thus, it is not an ideal design for the sales in the shops and arrangement by the users.

Second, regarding the ads effect: the space available for advertisement is only limited to the side wall 05 of the conventional soft package 02, without mentioning the overlapped portion around the side wall 05, so the commercial effect of the conventional soft package 02 is not suitable for marking purpose.

Given that the shortcomings of the above conventional soft package 20, some soft package manufacturers provide different soft package for overcoming the shortcomings of the above conventional soft package 20, wherein the altered soft package has a T-shaped side plan view. However, it is easy to form a triangle gap 06 between a horizontal structure and a straight structure, as shown in FIG. 10 such that the yield rate of manufacturing the conventional soft package is reduced and the cost of manufacturing the conventional soft package is raised.

The present invention has arisen to mitigate and/or obviate the disadvantages of the structures and the manufacturing method of the conventional soft packages.

### BRIEF SUMMARY OF THE INVENTION

The main objective of the present invention is to provide an improved manufacturing method of a soft package for forming two strengthened hot-pressing traces on the soft package, wherein the soft package includes a first side wall, a second side wall, a top wall and a nozzle hot-pressed to one another.

To achieve the objective, the manufacturing method of a soft package in accordance with the present invention comprises the following steps of: preparing a first material tape for forming the first side wall, preparing a second material tape for forming the second side wall and preparing a third material tape for forming the top wall. The first material tape is parallel to the second material tape via a first guiding means. A top portion of the second material tape is folded along a folding line to form a folded portion via a bending means. The third material tape is transmitted to correspond to the folded portion of the second material tape and aligns with the folded portion and the first side wall via a second guiding means. A nozzle feeding device is disposed and corresponds to a moving route of the third material tape and a series of through holes is defined in the third material tape via a punching means. The nozzle feeding device provides a nozzle extending through each through hole in the third material tape, wherein the nozzle is secured adhered to a periphery of a corresponding one of the through holes via a first hot-pressing means. A partition is disposed between the folded portion and the second material tape via a separating means. The piled first material tape, the second material tape and the third material tape are hot-pressed to form a closed hot-pressing trace via a second hot-pressing means such that the third material tape is secured to the folded portion and a top portion of the first material tape. The piled first material tape and the second material tape are not adhered to each other due to the separating means. The piled first material tape and the second material tape are adhered to each other via a third hot-pressing means, wherein the hot-pressing trace, due to the third hot-pressing means, extends to a top edge of the second material tape over the top wall. The adhered first material tape, the second material tape and the top wall are cut along the hot-pressing traces formed by the third hot-pressing means via a cutting means to form a finished soft package.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of a soft package in accordance with the present invention.

FIG. 2 is a perspective view of the soft package in accordance with the present invention.

FIG. 3 is a perspective view of the soft package in accordance with the present invention after removing a cap thereof.

FIG. 4 is a cross-sectional view of the soft package in accordance with the present invention along the line 4-4 in FIG. 3.

FIG. 5 shows a status view of a manufacturing method of the soft package in accordance with the present invention.

FIG. 6 shows a status view of a manufacturing method of the soft package in accordance with the present invention when providing a partition.

FIG. 7 shows a status view of a manufacturing method of the soft package in accordance with the present invention during a first hot-pressing step.

FIG. 7A is a cross-sectional view of a semi-finished product of the soft package in accordance with the present invention.

FIG. 8 shows a status view of a manufacturing method of the soft package in accordance with the present invention during a second hot-pressing step.

FIG. 9 is perspective view of a conventional soft package in accordance with the prior art.

FIG. 10 is partially perspective view of another conventional soft package in accordance with the prior art.

### DETAILED DESCRIPTION OF THE INVENTION

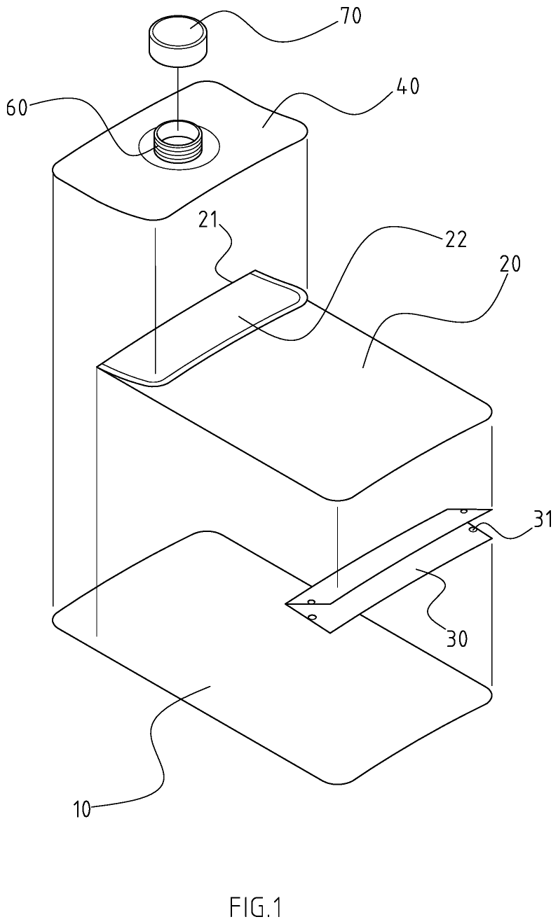

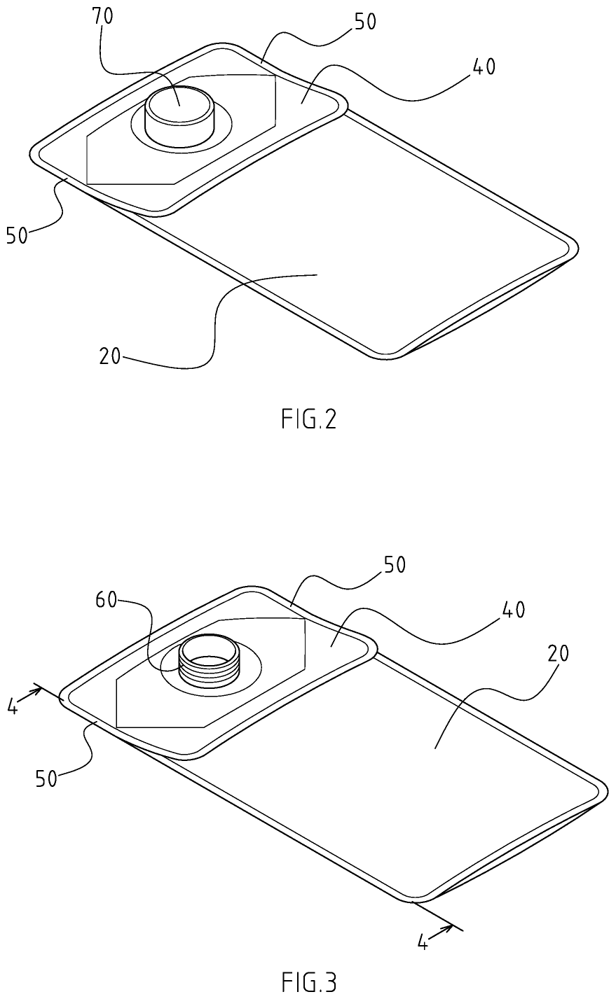

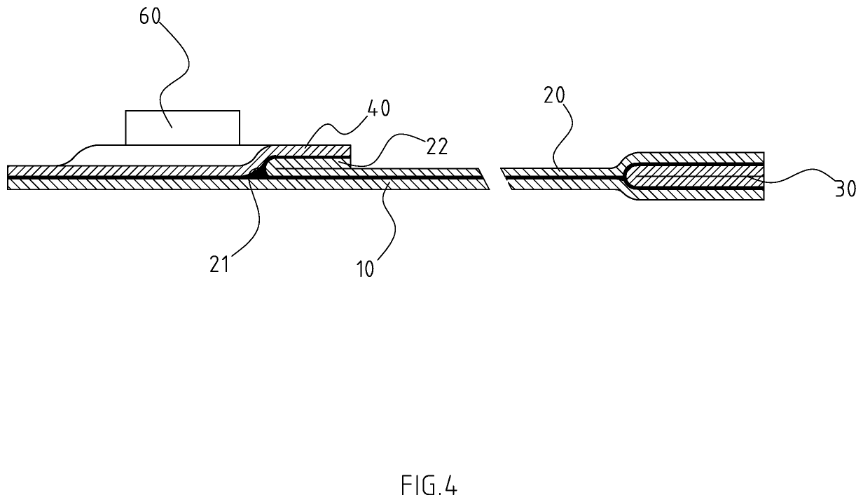

Referring to the drawings and initially to FIGS. 1-4, a soft package with strengthened hot pressing traces in accordance with the present invention comprises a first side wall 10 and a second side wall 20 having a shape and an area corresponding to that of the first side wall 10. The second side wall 10 is formed with a folded portion 22 along a folding line 21. The distal edge of the second side wall 20 is securely adhered to that of the first side wall 10 except of the folding line 21 and the distal edge of the folded portion 22. A bottom wall 30 is disposed between lower portions of the first side wall 10 and the second side wall 20, wherein the bottom wall 30 is folded into two portions respective to the lower portion of the first side wall 10 and the second side wall 20. A top wall 40 is divided into a first portion and a second portion by the folding line 21, wherein a distal edge of the first portion of the top wall 40 is securely adhered to that of the folded portion 22 and a distal edge of the second portion is securely adhered to that of a top portion of the first side wall 10 to form a bag structure. Two strengthened pressing traces 40 are formed on two opposite sides of the top wall 40 and correspond to two opposite outer sides of the first side wall 10 and the second side wall 20. A nozzle 60 is mounted onto the top wall and outwardly extends through the top wall 40, wherein the nozzle 60 communicates with an inner periphery of the bag structure. A cap 70 is selectively mounted onto the nozzle 60 for selectively closing the nozzle 60.

The bottom wall 30 has two opposite sides each having a through hole 31 defined therein such that the first side wall 10 and the second side wall 20 are partially secured adhered to each other via the through holes 31 in the bottom wall 30.

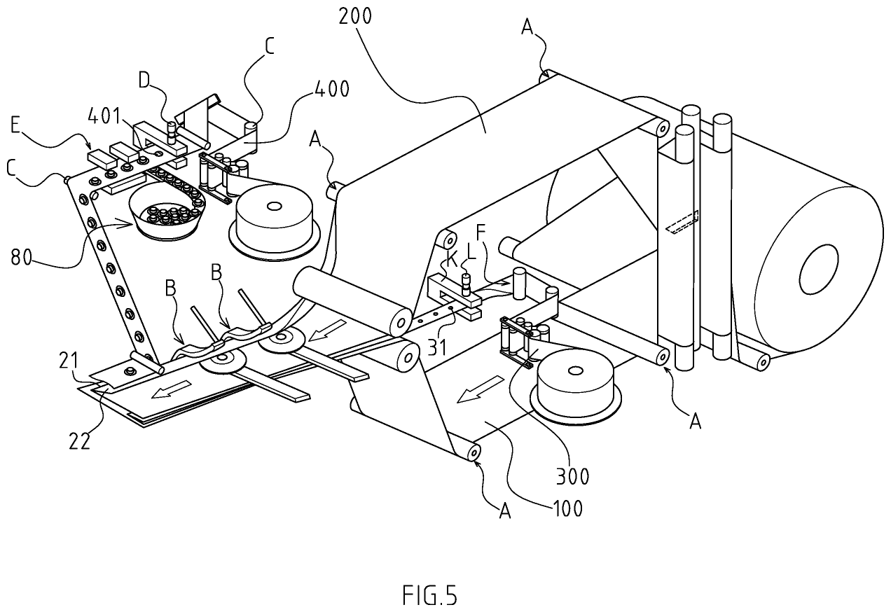

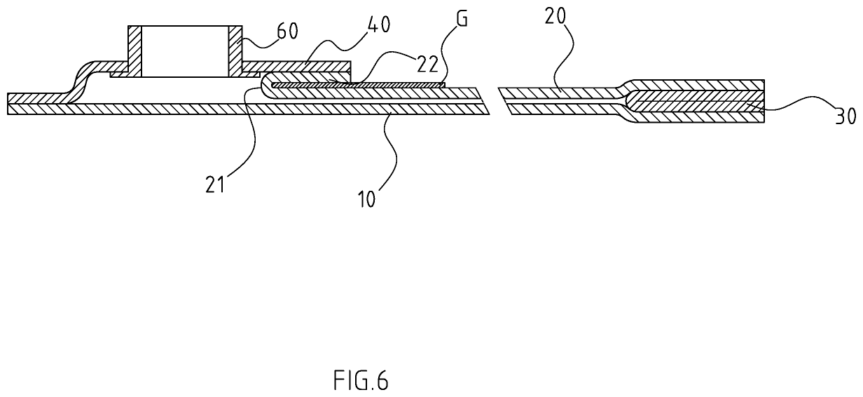

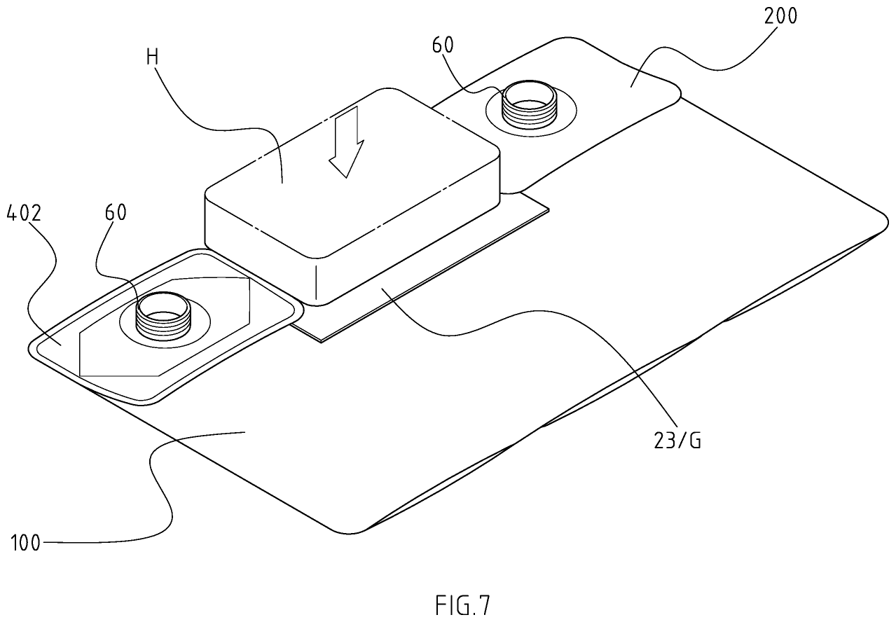

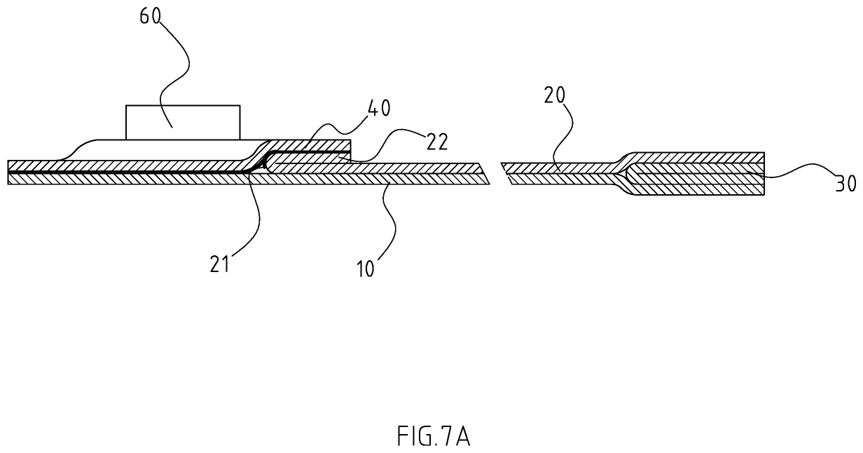

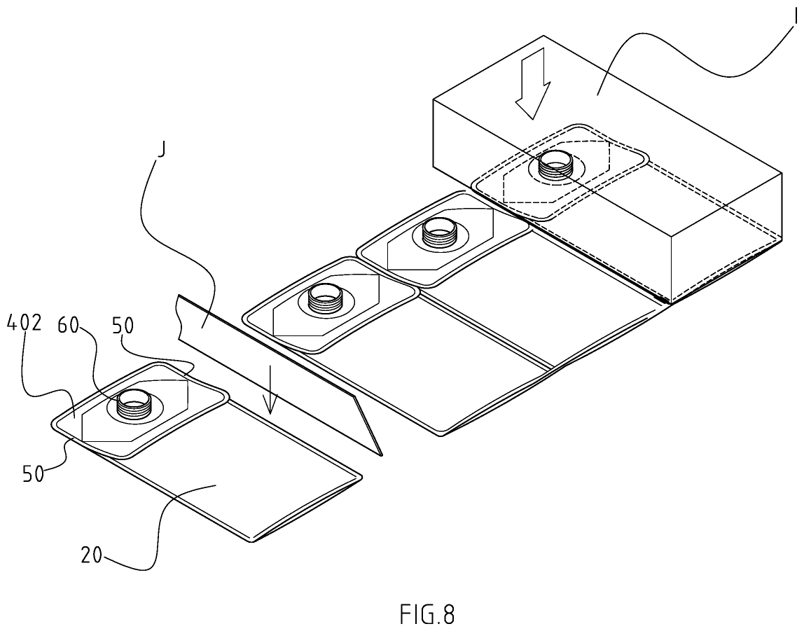

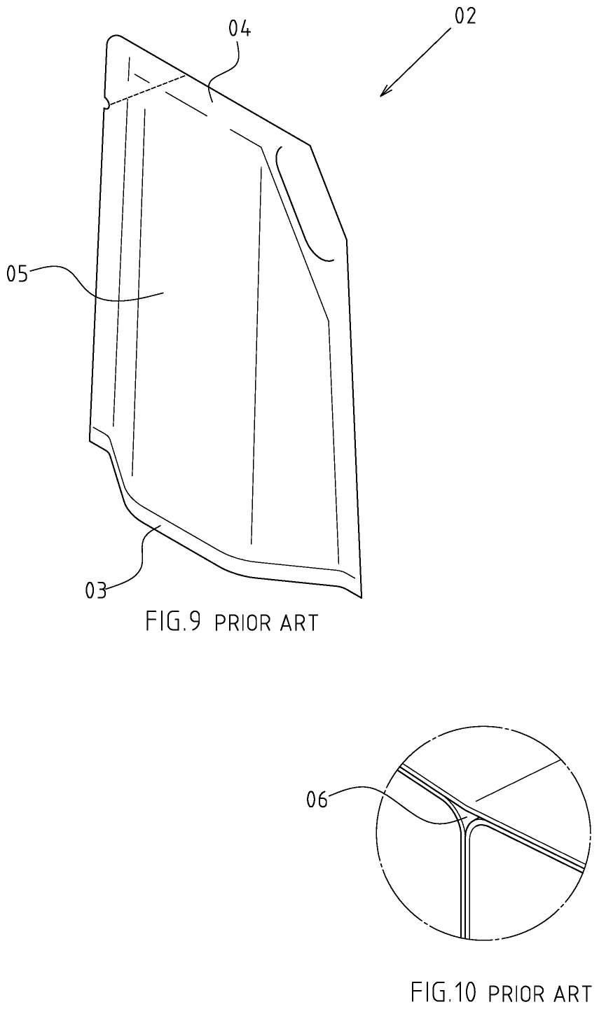

With reference to FIGS. 5 to 8, a manufacturing method of the above soft package, including a first side wall 10, a second side wall 20, a top wall 40, a bottom wall 30 and a nozzle 60, comprises the following steps of: preparing a first material tape 100 for forming the first side wall 10; preparing a second material tape 200 for forming the second side wall 20; preparing a third material tape 400 for forming the top wall 40 and preparing a fourth material tape 300 for forming the bottom wall 30. The first material tape 100 is parallel to the second material tape 200 via a first guiding means. A top portion of the second material tape 200 is folded along a folding line 21 to form a folded portion 22 via a bending means B. The third material tape 400 is transmitted to correspond to the folded portion 22 of the second material tape 200 and aligns with the folded portion 22 and the first side wall 10 via a second guiding means C. A nozzle feeding device 80 is disposed and corresponding to a moving route of the third material tape 400 and a series of through holes 401 is defined in the third material tape 400 via a punching means D. The nozzle feeding device 80 provides a nozzle 60 extending through each through hole 401 in the third material tape 400, wherein the nozzle 80 is secured adhered to a periphery of a corresponding one of the through holes 401 via a first hot-pressing means E. The fourth material tape 300 is transmitted to a place between the first material tape 100 and the second material tape 200 opposite to the folded portion 22 via a third guiding means F. A partition 23 is disposed between the folded portion 22 and the second material tape 200 via a separating means G. The piled first material tape 100, the second material tape 200 and the third material tape 400 is hot-pressed to form a closed hot-pressing trace 402 via a second hot-pressing means H such that the third material tape 400 is secured to the folded portion 22 and a top portion of the first material tape 100. With reference to FIG. 7A, the piled first material tape 100 and the second material tape 200 are not adhered to each other due to the separating means G. The piled first material tape 100 and the second material tape 200 are adhered to each other via a third hot-pressing means I, wherein the hot-pressing trace, due to the third hot-pressing means I, extends to a top edge of the second material tape 200 over the top wall 40. The adhered first material tape 100, the second material tape 200 and the top wall 400 are cut along the hot-pressing traces formed by the third hot-pressing means I via a cutting means J to form a finished soft package in accordance with the present invention. The two opposite sides of the top wall 40 are hot-pressed twice due to the second hot-pressing means H and the third hot-pressing means I such that two strengthened hot-pressing traces 50 are formed on the two opposite sides of the top wall 40 and correspond to two opposite outer sides of the first side wall and the second side wall for promoting the bondability among the first side wall 10, the second side wall 20 and the top wall 40.

The manufacturing method in accordance with the present invention further comprises a folding means K following the third guiding means F. The fourth material tape 300 is folded and divided into two portions via the folding means K and the two portions of the fourth material tape 300 are respectively adhered to the first material tape 100 and the second material tape 200 via the third hot-pressing means I. The manufacturing method in accordance with the present invention further comprises a slotting means L following the folding means K. There is a series of through holes 31 defined in the folded fourth material tape 300 via the slotting means L, wherein the first material tape 100 and the second material tape 200 are partially adhered to each other due to the series of through holes 31 in the folded fourth material tape 300 via the third hot-pressing means I.

Although the invention has been explained in relation to its preferred embodiment, it is to be understood that many other possible modifications and variations can be made without departing from the spirit and scope of the invention as hereinafter claimed.

I claim:

1. A soft package with strengthened hot pressing traces, comprising:
a first side wall;
a second side wall having a shape and an area corresponding to that of the first side wall, wherein the second side wall is formed with a folded portion along a folding line and the distal edge of the second side wall is securely adhered to that of the first side wall except of the folding line and the distal edge of the folded portion;
a top wall divided into a first portion and a second portion by the folding line, wherein a distal edge of the first portion of the top wall is securely adhered to that of the folded portion and a distal edge of the second portion is securely adhered to that of a top portion of the first side wall to form a bag structure; and
two strengthened pressing traces formed on two opposite sides of the top wall and corresponding to two opposite outer sides of the first side wall and the second side wall; and
a nozzle mounted onto the top wall and outwardly extending through the top wall, wherein the nozzle communicates with an inner periphery of the bag structure.

2. The soft package with strengthened hot pressing traces as claimed in claim 1, further comprising a bottom wall disposed between lower portions of the first side wall and the second side wall, wherein the bottom wall is folded into two portions respective to the lower portion of the first side wall and the second side wall.

3. The soft package with strengthened hot pressing traces as claimed in claim 2, further comprising a cap selectively mounted onto the nozzle for selectively closing the nozzle.

4. The soft package with strengthened hot pressing traces as claimed in claim 1, wherein the bottom wall has two opposite sides each having a through hole defined therein such that the first side wall and the second side wall are partially secured adhered to each other via the through holes in the bottom wall.

5. The soft package with strengthened hot pressing traces as claimed in claim 2, wherein the bottom wall has two opposite sides each having a through hole defined therein such that the first side wall and the second side wall are partially secured adhered to each other via the through holes in the bottom wall.

6. The soft package with strengthened hot pressing traces as claimed in claim 3, wherein the bottom wall has two opposite sides each having a through hole defined therein such that the first side wall and the second side wall are partially secured adhered to each other via the through holes in the bottom wall.

7. A manufacturing method of a soft package, including a first side wall, a second side wall, a top wall and a nozzle hot-pressed to one another, comprising the following steps of:
preparing a first material tape for forming the first side wall;
preparing a second material tape for forming the second side wall;
preparing a third material tape for forming the top wall;
the first material tape being parallel to the second material tape via a first guiding means;
a top portion of the second material tape being folded along a folding line to form a folded portion via a bending means;
the third material tape being transmitted to correspond to the folded portion of the second material tape and aligning with the folded portion and the first side wall via a second guiding means;
a nozzle feeding device disposed and corresponding to a moving route of the third material tape and a series of through holes defined in the third material tape via a punching means, the nozzle feeding device providing a nozzle extending through each through hole in the third material tape, wherein the nozzle is secured adhered to a periphery of a corresponding one of the through holes via a first hot-pressing means;
a partition disposed between the folded portion and the second material tape via a separating means;
the piled first material tape, the second material tape and the third material tape being hot-pressed to form a closed hot-pressing trace via a second hot-pressing means such that the third material tape is secured to the folded portion and a top portion of the first material tape, the piled first material tape and the second material tape being not adhered to each other due to the separating means;
the piled first material tape and the second material tape being adhered to each other via a third hot-pressing means, wherein the hot-pressing trace, due to the third hot-pressing means, extends to a top edge of the second material tape over the top wall;
the adhered first material tape, the second material tape and the top wall being cut along the hot-pressing traces formed by the third hot-pressing means via a cutting means to form a finished soft package.

8. The manufacturing method as claimed in claim 7, further comprising a step of preparing a fourth material tape for forming a bottom wall of the soft package, wherein the step of preparing a fourth material tape is disposed between the step of preparing a third material tape and the step of the first material tape being parallel to the second material tape via a first guiding means, and wherein the bottom wall is folded and securely adhered to the first side wall and the second side wall via a third hot-pressing means;

9. The manufacturing method as claimed in claim 8, wherein the fourth material tape is transmitted to a place between the first material tape and the second material tape opposite to the folded portion via a third guiding means.

10. The manufacturing method as claimed in claim 9, further comprising a folding means following the third guiding means, wherein the fourth material tape is folded and divided into two portions via the folding means and the two portions of the fourth material tape are respectively adhered to the first material tape and the second material tape via the third hot-pressing means.

11. The manufacturing method as claimed in claim 9, further comprising a slotting means following the folding means, wherein there is a series of through holes defined in the folded fourth material tape via the slotting means, and the first material tape and the second material tape are partially adhered to each other due to the series of through holes in the folded fourth material tape via the third hot-pressing means.

12. The manufacturing method as claimed in claim 10, further comprising a slotting means following the folding means, wherein there is a series of through holes defined in the folded fourth material tape via the slotting means, and the first material tape and the second material tape are partially adhered to each other due to the series of through holes in the folded fourth material tape via the third hot-pressing means.
